(19) United States
(12) Patent Application Publication
(10) Pub. No.: US 2013/0159269 A1
(43) Pub. Date: Jun. 20, 2013

(54) A METHOD FOR OUTPUTTING RESCUE-RELEVANT INFORMATION, AND A SYSTEM

(71) Applicants: Volker Blaschke, Ludwigsburg (DE); Andreas-Juergen Rohatschek, Wernau/Necker (DE); Clemens Schroff, Kraichtal (DE)

(72) Inventors: Volker Blaschke, Ludwigsburg (DE); Andreas-Juergen Rohatschek, Wernau/Necker (DE); Clemens Schroff, Kraichtal (DE)

(21) Appl. No.: 13/702,086

(22) PCT Filed: Apr. 15, 2011
(86) PCT No.: PCT/EP2011/055993

§ 371 Date: Feb. 20, 2013

(30) Foreign Application Priority Data
Jun. 8, 2010 (DE) 10 2010 029 811.5

(51) Int. Cl. G06F 17/30

(52) U.S. Cl. CPC G06F 17/30386
USPC 707/705

(57) ABSTRACT

A method for outputting rescue-relevant information, the method includes reading out an information carrier on a vehicle, the information carrier including information that characterizes rescue-relevant information; and displaying the rescue-relevant information on a mobile device as a function of the read-out information.

### FIELD

The present invention relates to a method for outputting rescue-relevant information, and it relates to a system.

### BACKGROUND INFORMATION

The article “Die Rettungskarte” [The Rescue Map] published on Feb. 10, 2010 on the web site of the ADAC [German Automobile Club] (www.adac.de), for example, describes endeavors in the automotive sector to equip vehicles with a rescue map. This rescue map contains rescue-relevant information, which is meant to simplify the rescue of a person in an automobile involved in an accident, and to reduce the rescue time, in particular. Such rescue-relevant information, for example, includes the points on the vehicle body where hydraulic rescue tools such as yaws of life are to engage, or also indicates protective measures required in order to prevent the retroactive triggering of airbags. Such a rescue map is shown in FIG. 1 by way of example. The rescue map is to be mounted behind the sun visor on the driver side, for instance.

### SUMMARY

An example method according to the present invention for outputting rescue-relevant information, and an example system according to the present invention have the advantage that the rescue-relevant information is able to be displayed on a mobile device of the person performing or controlling the rescue operation. As a result, it is no longer necessary to carry a rescue map in the form of a document in the motor vehicle. Access to the rescue-relevant information according to the present invention also is very easy, since physical entry into the motor vehicle in order to obtain the rescue-relevant information is no longer required.

### BRIEF DESCRIPTION OF THE DRAWINGS

Exemplary embodiments of the present invention are shown in the figures and discussed in greater detail below.

FIG. 1 shows a conventional rescue map.

FIG. 2 shows an example system according to one exemplary embodiment of the present invention.

FIG. 3 shows the mobile device from FIG. 2 in a detail view.

### DETAILED DESCRIPTION OF EXAMPLE EMBODIMENTS

Unless stated otherwise, identical reference numerals in the figures denote identical or functionally equivalent elements.

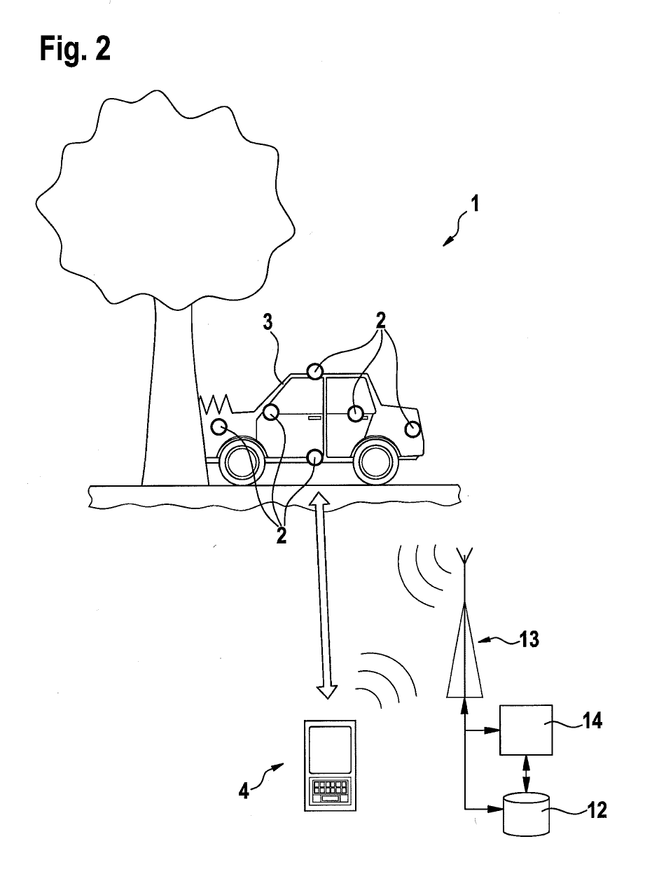

FIG. 2 shows a system 1 according to one exemplary embodiment of the present invention.

System 1 includes a motor vehicle 3 equipped with one or multiple information carrier(s) 2. Information carriers 2 are also mounted on the motor vehicle. In the case at hand, “on the motor vehicle” also includes information carriers 2 provided inside motor vehicle 3.

According to the exemplary embodiment at hand, information carriers 2, for example, are a multitude of RFID chips, which are distributed across the motor vehicle. For instance, it is possible to mount them inside and/or outside the passenger compartment, in the trunk, in the engine compartment, and/or in or on the floor of motor vehicle 3. This multitude of information carriers 2 distributed across motor vehicle 3 ensures that at least one of these information carriers 2 remains intact, i.e., is not destroyed, during an accident illustrated in FIG. 2.

Instead of the RFID chip, information carrier 2 could be implemented as bar code, smart code, a specific series of alphanumeric numbers on a sticker, the license plate of motor vehicle 3, and/or a data memory.

Each of these information carriers 2 preferably includes the same information that characterizes rescue-relevant information. “Rescue-relevant information” in this case is information that is important in the context of rescuing a person involved in an accident. Counted among this information, for example, is information about active safety systems, i.e., the system of airbags in the motor vehicle, information about passive safety systems, such as the system of side-impact protection devices in the motor vehicle, information about the fuel carried in the vehicle such as gas or hydrogen, and/or information about a special design model, e.g., special window glass, of the motor vehicle. A “motor vehicle” in this case denotes an individual motor vehicle or a motor vehicle model. For motor vehicle manufacturers, it appears to be especially useful to always store the same information characterizing the rescue-relevant information for multiple vehicles of a particular vehicle model on information carrier 2.

Preferably, the information is stored on the information carrier in electronic format. This is advantageous in particular for the vehicle manufacturer, since it allows the manufacturer to use the same information carrier for different motor vehicles or different motor vehicle models, for different rescue-relevant information.

The information that characterizes the rescue-relevant information may involve the rescue-relevant information itself as defined above. In the same way and actually preferred in the present case, the data may allow an assignment of rescue-relevant information to the particular motor vehicle or motor vehicle model. As a result, only a few items of information must be stored on the information carrier.

System 1 furthermore is equipped with a mobile device 4. This device 4 allows the display of the rescue-relevant information as a function of the information read out from information carrier 2.

Several example possibilities exist in this context:

For example, mobile device 4 may communicate in wireless manner with information carriers 2 in the form of RFID chips, the information that characterizes the rescue-relevant information being transmitted to mobile device 4 in the process.

As an alternative, it is also possible that mobile device 4 has a bar code or smart code reader, which may be used to read out information carriers 2 implemented as bar codes or smart codes, in order to thus transmit the information characterizing the rescue-relevant information to mobile device 4.

Furthermore, it is also possible that a user person inputs the rescue-relevant information into mobile device 4 either manually or via speech recognition.

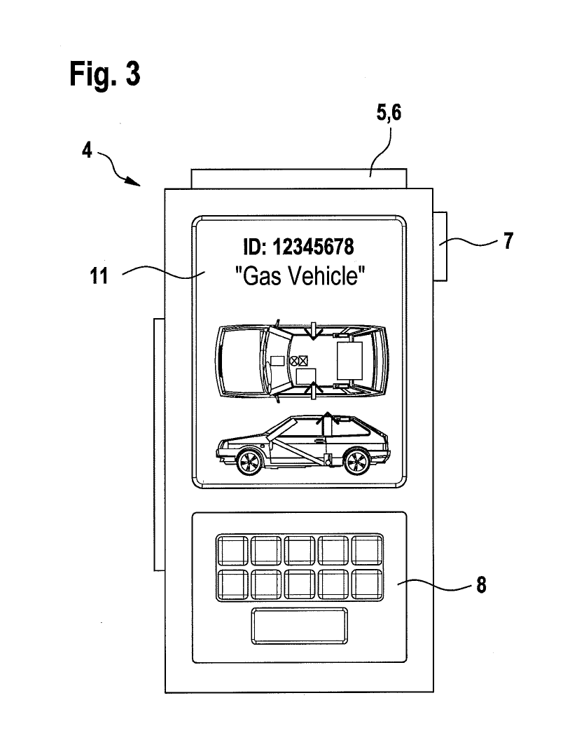

Accordingly, mobile device 4 as shown in FIG. 3 may include a bar code reader 5, an RFID reader 6, a transmit/receive antenna 7, and or an operator panel 8.

In the event that the information that describes the rescue-relevant information itself is stored on information carrier 2, it is easily possible to transmit it to mobile device 4 and to display it to the person performing or controlling the rescue operation.

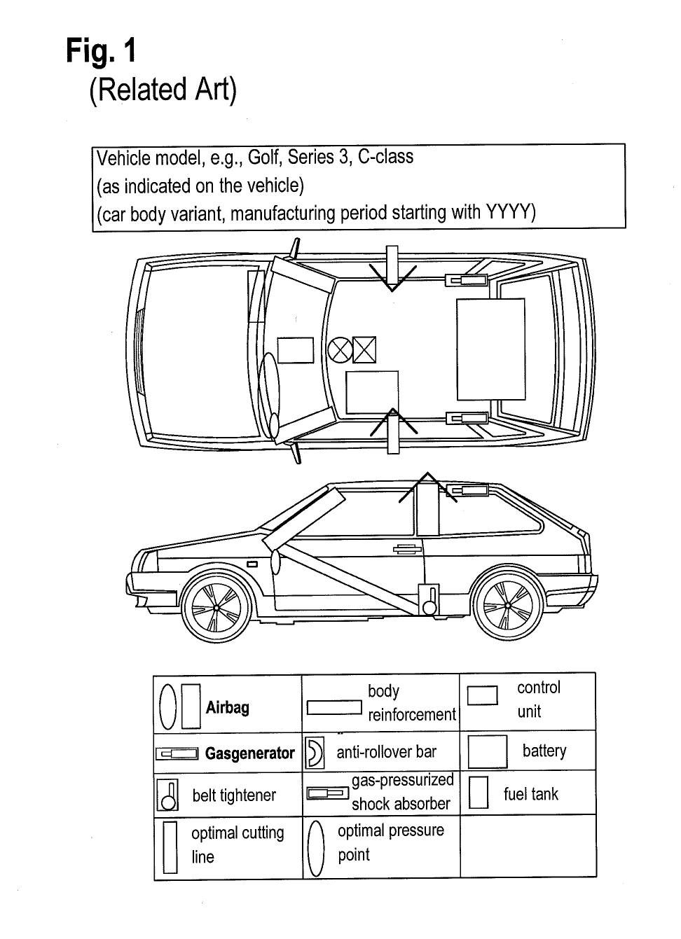

The rescue-relevant information is able to be displayed on mobile device 4, for instance on a screen 11 of the device, as illustrated in FIG. 3. The display generally corresponds to the display known from FIG. 1. Mobile device 4 may reproduce the rescue-relevant information as text, image or video data. For example, the display of a video to guide a cut through motor vehicle 3 using a corresponding saw is conceivable. In addition, mobile device 4 can also output the rescue-relevant data in the form of voice output.

In the case at hand, an approach is preferred in which, as already discussed above, only an item of information that allows an assignment of the rescue-relevant information to corresponding motor vehicle 3 or the motor vehicle model is transmitted from information carrier 2 to mobile device 4. This type of information is referred to as “identification characteristic” in the case at hand.

According to one exemplary embodiment of the present invention, it is possible that a database is stored on mobile device 4. This database contains corresponding rescue-relevant information for the various motor vehicle types that are identified via their identification characteristic in the database. If the identification characteristic then is transmitted from information carrier 2 to mobile device 4, the data set linked to the identification characteristic will be displayed on screen 11. This is shown in FIG. 3 by way of example. Screen 11 of mobile device 4 shows the identification characteristic “ID 12345678” of motor vehicle 3 and also rescue-relevant information assigned to this identification characteristic.

Mobile device 4 may be set up to allow updating of the database. For example, this may be done by connecting mobile device 4 to a central database 12, for instance via RS232, Ethernet, Bluetooth, WLAN, USB or mobile radio communication. Especially preferred is a development in which mobile device 4 is able to establish a radio connection 13 to database 12.

According to another exemplary embodiment, which is preferred in this case, mobile device 4 itself does not have a database but merely an internal data memory. In this case mobile device 4 queries central database 12 based on the identification characteristic, especially via radio link 13, which then transmits the data set assigned to the identification characteristic to mobile device 4, preferably via radio link 13 once again. Mobile device 4 thereupon displays this data set 4, which is stored in the previously mentioned internal data memory of mobile device 4, on screen 11.

Database 12 may be part of a communication network, e.g., the Internet. The different automobile manufacturers preferably update database 12 on a regular basis.

Radio link 13 may be part of a mobile radio communication network, for instance.

Moreover, system 1 may have an additional database 14. Rescue-relevant information specially compiled by rescue personnel, which likewise is assigned to a particular motor vehicle type via an identification characteristic, is able to be stored there. This additional database 14, for example, may be assigned to a central dispatcher station of the fire department, i.e., the data in database 14 are maintained and updated by the fire department. Databases 12 and 14 may of course be integrated with one another.

The afore-described system and the afore-described method thus allow a more rapid, automated provision of rescue-relevant information to rescue personnel, so that the rescue of the person involved in an accident is able to be simplified, especially accelerated.

The development of central database 12 advantageously makes it possible to store rescue-relevant information also retroactively, i.e., after motor vehicle 3 has been delivered by the automobile manufacturer. In addition, the owner of motor vehicle 3 is able to store the corresponding rescue-relevant information in database 12 when retrofitting the vehicle, such as with a gas drive.

Information carriers 2 developed as RFID chips may also be integrated into airbag components.

Although the present invention has been described in detail based on exemplary embodiments, it is not limited thereto but able to be modified in numerous ways. In particular, the further developments and exemplary embodiments described here for the system according to the present invention are correspondingly employable for the method according to the present invention, and vice versa. In addition, it should be pointed out that “a” does not exclude the plural.

1-10. (canceled)

11. A method for outputting rescue-relevant information, the method comprising:
reading out information that characterizes rescue-relevant information from an information carrier on a vehicle; and
displaying the rescue-relevant information on a mobile device as a function of the read-out information.

12. The method as recited in claim 11, wherein the read-out information contains the rescue-relevant information itself.

13. The method as recited in claim 12, wherein the information carrier is a data memory, and the rescue-relevant information itself is stored in the data memory.

14. The method as recited in claim 11, further comprising:
reading out a database containing the rescue-relevant information as a function of the information read out from the information carrier.

15. The method as recited in claim 14, wherein the information carrier is at least one of an RFID chip, a bar code, a sticker, and a license plate.

16. The method as recited in claim 14, wherein the database is stored on the mobile device.

17. The method as recited in claim 14, wherein the database is a central database which transmits the rescue-relevant information to the mobile device in wireless manner.

18. The method as recited in claim 11, wherein the information carrier reads the information that characterizes rescue-relevant information into the mobile device in a wireless manner.

19. The method as recited in claim 11, wherein the rescue-relevant information contains information about at least one of active safety systems, passive safety systems, fuel, and windows of the vehicle.

20. A system, comprising:
an information carrier on a vehicle containing information that characterizes rescue-relevant information; and
a mobile device to display the rescue-relevant information thereon as a function of information read out from the information carrier.
